(19) United States
(12) Patent Application Publication
(10) Pub. No.: US 2020/0332204 A1
(43) Pub. Date: Oct. 22, 2020

(54) PROCESS FOR PURIFICATION OF HYDROCARBONS

(71) Applicant: HALDOR TOPSØE A/S, Kgs. Lyngby (DK)

(72) Inventors: Muhammad ILYAS, Kokkedal (DK); Liza LINDMARK, Malmö (SE); Ole Frej ALKILDE, Valby (DK)

(73) Assignee: HALDOR TOPSØE A/S, Kgs. Lyngby (DK)

(21) Appl. No.: 16/643,103

(22) PCT Filed: Oct. 9, 2018
(86) PCT No.: PCT/EP2018/077403

§ 371 Date: Feb. 28, 2020

(30) Foreign Application Priority Data
Oct. 12, 2017 (DK) PA 2017 00577

(51) Int. Cl. C10G 53/08; C10G 67/14; B01D 53/14; B01D 53/18

(52) U.S. Cl. CPC C10G 53/08; C10G 67/14; B01D 53/1418; B01D 53/1468; B01D 53/18; C10G 2300/4006; B01D 2252/20489; C10G 2300/4018; C10G 2300/1044; C10G 2300/207; C10G 2300/308; C10G 2300/202; C10G 2300/4012

(57) ABSTRACT

Processes and equipment for purification of a sour hydrocarbon mixture or a gas mixture including hydrocarbons and sour gas, at least including the steps of directing the gas mixture to contact an absorbent liquid having affinity for sour gas, providing a purified off-gas mixture, directing the purified off-gas mixture to contact a liquid hydrocarbon mixture, providing an enriched liquid hydrocarbon mixture, with the associated benefit of such a process having a high recovery of hydrocarbons from the gas mixture to the enriched liquid hydrocarbon mixture, while being efficient in removing hydrogen sulfide from the gas mixture. The gas mixture to be purified may either be a natural gas, a fuel gas or an intermediate gas stream, e.g. from naphtha, kerosene, diesel or condensate hydrotreatment or hydrocracking, and it may also include further constituents, typically hydrogen.

The present disclosure relates to a process for purification of a gas mixture or a liquid hydrocarbon mixture, having a low yield loss.

In the processing of light hydrocarbons, it is often required to separate hydrogen sulfide from hydrocarbons. The hydrogen sulfide may either be present from the source of hydrocarbons or it may be generated during initial processing of the hydrocarbon. It is well known to separate sour gases, such as hydrogen sulfide and carbon oxides from other gases by absorption in amine solutions or other liquids, but the purified gas may contain light hydrocarbons, which may not be recovered, and thus released e.g. to flare.

It has now been identified that the recovery of hydrocarbons may be increased by contacting the purified gas, comprising light hydrocarbons, with an absorbing hydrocarbon. In this manner, the recovery of hydrocarbons may be increased. Especially in the case where an appropriate absorbent hydrocarbon is available, such a process is favorable. This is e.g. the case where a liquid hydrocarbon mixture is hydrotreated, followed by a separation in a liquid hydrocarbon fraction and a vapor fraction, since the liquid hydrocarbon fraction may be used as absorbent hydrocarbon.

For the purpose of the present application a light hydrocarbon shall be construed as a hydrocarbon with a boiling point of 50° C. or lower.

For the purpose of the present application the terminology Cn hydrocarbon shall be construed as a hydrocarbon with n carbon atoms, e.g. C5 hydrocarbons shall be construed as pentane isomers.

For the purpose of the present application a condensate oil shall be construed as a material being condensed from natural gas or associated gas from oil production, or having equivalent characteristics, especially boiling point, to such a material.

For the purpose of the present application the term heteroatomic hydrocarbon mixture shall be construed as a mixture of hydrocarbons, some of which contain other atoms than hydrogen and carbon, e.g. sulfur and nitrogen.

For the purpose of the present application the term hydrotreatment shall be construed as a process in which hydrogen reacts with a heteroatomic hydrocarbon, typically comprising sulfur or nitrogen, to replace heteroatoms with hydrogen, while releasing compounds such as hydrogen sulfide and ammonia. Hydrotreatment may also cover other reactions involving hydrocarbons and hydrogen, but such reactions shall not be considered further for the purpose of the present application.

For the purpose of the present application the term a feedstock comprising naphtha shall be construed as a having feedstock for which at least 30% by weight boils in the range 30° C. to 200° C.

For the purpose of the present application a sour gas shall be construed as a gas comprising hydrogen sulfide and/or ammonia, typically in combination with other constituents. A sour hydrocarbon mixture shall be construed as a mixture comprising at least a sour gas and one or more hydrocarbons.

For the purpose of the present application the term fluid communication shall be construed as any substantial unhindered connection between two process elements, including but not limited to the connection via tubes, via the same thermal side of heat exchangers, but excluding the connection through a catalyst filled reactor.

For the purpose of the present application the Reid Vapor Pressure, RVP, shall be construed as the vapor pressure measured at 37.8° C., in accordance with the standard ASTM-D-323. The RVP value will indicate the amount of light hydrocarbons in a hydrocarbon mixture; a low RVP value will correspond to fewer light hydrocarbons compared to a similar hydrocarbon mixture with a higher RVP value.

A process for purification of a gas mixture comprising hydrocarbons and sour gas may comprise the steps of

directing the gas mixture to contact an absorbent liquid having affinity for sour gas, providing a purified off-gas mixture,

directing the purified off-gas mixture to contact a liquid hydrocarbon mixture, providing an enriched liquid hydrocarbon mixture,

with the associated benefit of such a process having a high recovery of hydrocarbons from the gas mixture to the enriched liquid hydrocarbon mixture, while being efficient in removing hydrogen sulfide from the gas mixture. The gas mixture to be purified may either be a natural gas, a fuel gas or an intermediate gas stream, e.g. from naphtha, kerosene, diesel or condensate hydrotreatment or hydrocracking, and it may also comprise further constituents, typically hydrogen.

In a broad embodiment, the present invention relates to a process for purification of a sour hydrocarbon mixture comprising the steps of

directing said sour hydrocarbon mixture to a means of separation, optionally a stripper, providing a liquid hydrocarbon fraction and a gas mixture,

directing the gas mixture to contact an absorbent liquid having affinity for sour gas, providing a purified off-gas mixture,

directing the purified off-gas mixture to contact a liquid hydrocarbon mixture, providing an enriched liquid hydrocarbon mixture,

with the associated benefit of such a process having a high recovery of hydrocarbons from the sour hydrocarbon mixture to the enriched liquid hydrocarbon mixture, while being efficient in removing hydrogen sulfide. The sour hydrocarbon mixture may be a product from the separation section of a hydroprocessing unit, an intermediate stream in a hydrocracker fractionation section or a product from a crude oil distillation unit.

In a further embodiment said absorbent liquid having affinity for sour gas has a temperature in the range from 30° C. or 50° C. to 60° C. or 90° C. and a pressure in the range of atmospheric pressure to 30 barg, with the associated benefit of a process in which the absorbent liquid operates at this temperature being effective in capture of hydrogen sulfide and ammonia, while operating at a pressure matching the pressure of the destination of the purified gas, e.g. 0-1 barg for an off-gas will sent to flare, 6-12 barg for a fuel gas system or 25-30 barg for hydrogen recovery.

In a further embodiment said absorbent liquid comprises an amine, such as an amine taken from the group comprising monoethanolamine, diethanolamine and methyl diethanolamine, an inorganic base, such as NaOH, KOH, NaHCO₃ or NaH₂CO₃, an ionic liquid or a physical solvent, comprising one or more compounds taken from the group comprising methanol, dimethyl ethers of polyethylene glycol, propylene carbonate and n-methyl-2-pyrrolidone, with the associated benefit of such absorbent liquids being highly effective in absorbing sour gases, such as hydrogen sulfide and ammonia.

In a further embodiment said liquid hydrocarbon mixture has a temperature in the range from 30° C. or 40° C. to 60° C. or 70° C., when contacted with said gas mixture, with the associated benefit of a process in which the absorbent liquid operates at this temperature being effective in capture of C1-C5 hydrocarbons while optimizing cooling costs, e.g by limiting the cooling to 50° C. to 70° C. which may be achieved by air cooling or possibly by further cooling e.g. by water cooling to 30° C. to 50° C.

In a further embodiment said liquid hydrocarbon mixture comprises at least a part of said liquid hydrocarbon fraction, with the associated benefit of such a process not requiring addition of a liquid hydrocarbon mixture.

In a further embodiment said sour hydrocarbon mixture comprises at least 30% by weight, boiling in the range from 30° C. to 200° C., with the associated benefit of such a process being to provide a high recovery of hydrocarbons, in spite of involving a gas purification of a light hydrocarbon mixture with a high volatility.

In a further embodiment said sour hydrocarbon mixture comprises at least 2%, 5% or 10% hydrocarbons by weight, boiling below 50° C., with the associated benefit of such a process having a need for a high recovery of light hydrocarbons, in spite of involving a gas purification of a light hydrocarbon mixture with a high volatility.

A further aspect of the present disclosure relates to a process for production of a purified hydrocarbon mixture from a heteroatomic hydrocarbon mixture, which comprises the process steps for purification of a sour hydrocarbon mixture, wherein said heteroatomic hydrocarbon mixture is directed to contact a material catalytically active in hydrotreatment under hydrotreatment conditions, providing the sour hydrocarbon mixture, with the associated benefit of such a process being the ability to provide hydrotreatment of heteroatomic hydrocarbons with a minimal yield loss.

In a further embodiment said hydrotreatment conditions involve a temperature from 250° C. or 320° C. to 410° C. or 450° C., a pressure from 10 barg or 20 barg to 60 barg or 100 barg and a liquid hourly space velocity from 0.5 m³/m³/h or 1 m³/m³/h to 4 m³/m³/h or 8 m³/m³/h and said material catalytically active in hydrotreatment comprises molybdenum or tungsten optionally in combination with cobalt or nickel and supported on a support comprising a support material such as alumina, silica and alumina-silica, with the associated benefit of such conditions being highly efficient in hydrotreatment.

In a further embodiment said heteroatomic hydrocarbon mixture is a condensate oil, a feedstock comprising naphtha or a product from a hydrocracking process with the associated benefit of providing a minimal yield loss from the purification.

A further aspect of the present disclosure relates to a process unit for purification of a gas mixture comprising hydrocarbon and hydrogen sulfide comprising a sour gas absorber and an oil absorber, each having a gas inlet, a gas outlet, a liquid inlet and a liquid outlet, wherein the gas mixture is directed to the gas inlet of said sour gas absorber, and the gas outlet of said sour gas absorber is in fluid communication with said oil absorber gas inlet, and where said oil absorber liquid outlet provides a purified liquid hydrocarbon mixture, with the associated benefit of such a process plant providing a high recovery of light hydrocarbons to said liquid hydrocarbon mixture and thus minimal yield loss during purification.

In a further embodiment the process unit further comprises a means of separation having an inlet, a vapor outlet, a liquid outlet and optionally a stripping medium inlet, wherein said sour hydrocarbon mixture is directed to said inlet of the means of separation, and the vapor outlet of the means of separation is in fluid communication with the gas inlet of the sour gas absorber, and wherein the liquid outlet of the means of separation optionally is in fluid communication with the liquid inlet of the oil absorber, with the associated benefit of such a process having a high recovery of hydrocarbons from the sour hydrocarbon mixture to the enriched liquid hydrocarbon mixture, while being efficient in removing hydrogen sulfide.

A further aspect of the present disclosure relates to a process plant for production of a purified hydrocarbon mixture from a heteroatomic hydrocarbon mixture, comprising a hydrotreatment reactor having an inlet and an outlet, said hydrotreatment reactor containing a material catalytically active in hydrotreatment, wherein the heteroatomic hydrocarbon mixture is directed to the inlet of the hydrotreatment reactor and outlet of hydrotreatment reactor is in fluid communication with the inlet of the means of separation, with the associated benefit of such a process plant being the ability to provide hydrotreatment of the heteroatomic hydrocarbon mixture with a minimal yield loss.

In the processing of hydrocarbons, the removal of heteroatoms, such as sulfur and nitrogen, is important for the processability of the hydrocarbons as well as for the quality of the final product. This removal is routinely made by hydrotreatment, resulting in a product comprising a sour gas mixed with a purified hydrocarbon.

If the feedstock comprises a light fraction, or if hydrocracking takes place in the process, the product may comprise light hydrocarbons as well, including methane, ethane, propane, butane and pentane, and as hydrotreatment typically is carried out in presence of excess hydrogen, the product mixture will contain three categories of product; waste gases, hydrogen and hydrocarbon, which in an ideal process would be separated.

Removal of sour waste gases by selective absorption in selective absorption media is routine in refineries. Such a selective absorption media may comprise an amine, such as monoethanolamine, diethanolamine or methyl diethanolamine, an inorganic base, such as NaOH, KOH, NaHCO₃ or NaH₂CO₃, an ionic liquid, a physical solvent, such as methanol, dimethyl ethers of polyethylene glycol, propylene carbonate or n-methyl-2-pyrrolidone but other absorption media may also be used.

The separation of hydrogen from light hydrocarbons may also be carried out, either in a dedicated PSA unit, the hydrotreatment section or together with hydrogen product in a hydrogen plant, but where this is not carried out it may be accepted to lose an amount of light hydrocarbons, which are used for process heating or perhaps directed to hydrogen production. The amount of light hydrocarbons in a liquid hydrocarbon mixture, will be reflected in the Reid Vapor Pressure (RVP), and therefore specifying a minimum RVP value for a hydrocarbon mixture will implicitly define a high recovery of light hydrocarbons. However, RVP specifications exist especially for naphtha and gasoline to ensure e.g. sufficient vapor pressure for ignition while avoiding excessive vapor pressure, which may limit the ability to pump the fuel at high temperatures.

Now according to the present invention it has been realized that such a yield loss may be averted if the light hydrocarbons are recovered by absorption in a liquid hydrocarbon mixture. Light hydrocarbons have significantly higher solubility in liquid hydrocarbon mixtures, compared to hydrogen, and therefore directing the purified hydrocarbon mixture to contact a liquid hydrocarbon mixture in an absorber will efficiently transfer light hydrocarbons from the gas phase to the liquid phase, without significant removal of hydrogen. The result will be a gas phase comprising hydrogen and only a low share of the light hydrocarbons, and a liquid hydrocarbon mixture having a higher share of the light hydrocarbons.

Such a process is especially relevant in the case where an appropriate liquid hydrocarbon mixture is already available in the process. This is for instance the case where a feedstock comprising gaseous hydrocarbons and liquid hydrocarbons, such as naphtha or condensate oil, is hydrotreated, but other hydrocarbon feedstocks may also require a similar increase in yield recovery, e.g. if a process with cracking activity is employed—either by design or due to side reactions in the process.

One embodiment of the present disclosure involves separation of vapor from liquid in a stripper. If the stripper is configured as a reboiling stripper, the stripping medium is evaporated feed, and thus addition of stripping medium is not required. Alternatively, the stripper may receive a stripping medium such as steam, fuel gas or hydrogen from an external source.

In the operation of the stripper, the amount of stripping medium (i.e. the duty of the reboiler for a reboiling stripper) will influence the amount of hydrogen sulfide removed in the stripper. In addition, the stripper will be equipped with a condenser, to limit the release of product in the vapor phase.

By the addition of an oil absorber, the ability to control the release of product in the vapor phase is increased, since the oil absorber may recover product which was not recovered by the condenser.

### FIGURES

FIG. 1 shows a process for purification of a gas mixture comprising hydrocarbons and sour gas, according to the present disclosure

FIG. 2 shows a process for purification of a heteroatomic hydrocarbon mixture, according to the present disclosure.

FIG. 3 shows a process for purification of a heteroatomic hydrocarbon mixture, according to the prior art.

Elements shown in the figures:
2 heteroatomic hydrocarbon mixture
4 hydrotreatment section
6 sour hydrocarbon mixture
8 stripper
10 gas mixture
12 liquid hydrocarbon fraction from stripper
14 sour gas absorber
16 absorbent liquid having affinity for sour gas
18 absorbent liquid rich in sour gas
20 purified off-gas
22 oil absorber
24 liquid hydrocarbon mixture
26 enriched liquid hydrocarbon mixture.
28 off-gas
30 Liquid hydrocarbon product

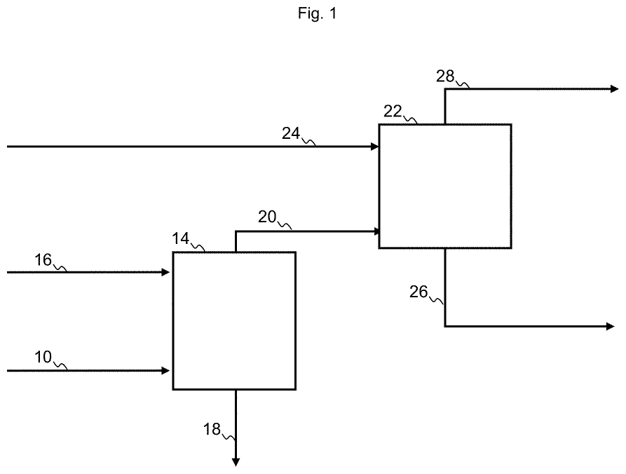

In FIG. 1 a process for purification of a gas mixture 10 comprising hydrocarbon and a sour gas impurity is shown. The gas mixture may also contain other constituents, including hydrogen. The gas mixture 10 is directed to a gas inlet of a sour gas absorber 14, containing an absorbent liquid having affinity for sour gas. The sour gas absorber 14 further has an inlet for lean sour gas absorbent liquid 16, an outlet for rich sour gas absorbent liquid 18 and an outlet for purified off-gas 20. The purified off-gas 20 is directed to the liquid inlet of an oil absorber 22, containing a liquid hydrocarbon mixture. The oil absorber 22 further has an inlet for a lean liquid hydrocarbon mixture 24, an outlet for final purified off-gas 28 and an outlet for enriched liquid hydrocarbon mixture 26. As a result the enriched liquid hydrocarbon mixture will absorb the light hydrocarbons and thus contribute to an increased hydrocarbon recovery.

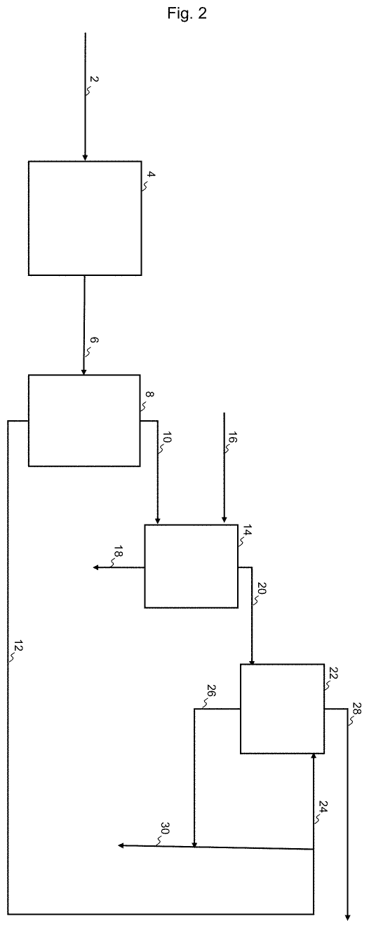

In FIG. 2 a process for purification of a heteroatomic hydrocarbon mixture 2 is shown. The heteroatomic hydrocarbon mixture 2, may e.g. be a condensate oil, a feedstock comprising naphtha or a product from a hydrocracking process comprising naphtha. The heteroatomic hydrocarbon mixture 2 is directed to a hydrotreatment section 4, comprising a reactor as well as a gas loop and a separator, as known in the art. The reactor contains a material catalytically active in hydrotreatment operating under hydrotreatment conditions. The material will typically comprise a base metal from Group 6 and a base metal from Group 8/9/10, most often Mo or W in combination with Ni or Co, on an appropriate support, such as alumina, silica or alumina-silica. From the outlet of the hydrotreatment section 4 a sour hydrocarbon mixture 6 is withdrawn, in which heteroatoms, such as sulfur or nitrogen, are converted into inorganic gases such as hydrogen sulfide or ammonia. The sour hydrocarbon mixture 6 is directed to the feed inlet of a means of separation, here a stripper 8 having a feed inlet, a liquid outlet and a vapor outlet. In addition to the sour hydrocarbon mixture 6 the stripper may receive a stripping medium but commonly it will operate by reboiling, providing the stripping medium by evaporation, and thus avoiding the cost and dilution due to an externally supplied stripping medium. The product is separated in a gas mixture 10 comprising hydrocarbon and sour gas withdrawn from the vapor outlet, and a liquid stripper product 12. The gas mixture 10 is directed to a gas inlet of a sour gas absorber 14, containing an absorbent liquid having affinity for sour gas. The sour gas absorber 14 further has an inlet for lean sour gas absorbent liquid 16, an outlet for rich sour gas absorbent liquid 18 and an outlet for purified off-gas 20. The purified off-gas 20 is directed to the liquid inlet of an oil absorber 22, containing a liquid hydrocarbon mixture. The oil absorber 22 further has an inlet for lean liquid hydrocarbon mixture 24, an outlet final purified off-gas 28 and an outlet for enriched liquid hydrocarbon mixture 26. In FIG. 2 at least an amount the liquid stripper product 12 is directed as lean liquid hydrocarbon mixture 24 to the oil absorber, and the enriched liquid hydrocarbon mixture 26 is combined with the lean liquid hydrocarbon mixture 24, to form the hydrocarbon product.

In an alternative embodiment the lean liquid hydrocarbon mixture 24 may be provided from an external source, instead of being an amount of liquid stripper product 12.

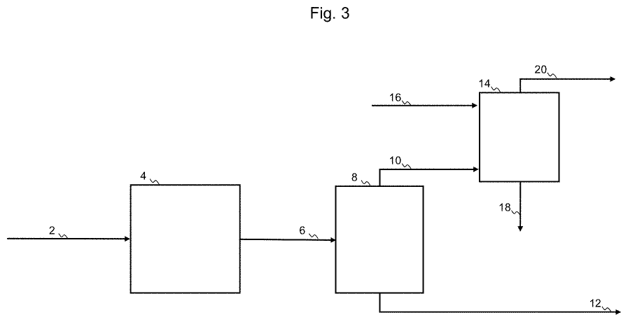

In FIG. 3 a process for purification of a heteroatomic hydrocarbon mixture 2 according to the prior art is shown. The heteroatomic hydrocarbon mixture 2, may be a condensate oil or a naphtha. The heteroatomic hydrocarbon mixture 2 is directed to a hydrotreatment reactor 4. From the outlet of the hydrotreatment reactor a sour hydrocarbon mixture 6 is withdrawn, in which heteroatoms, such as sulfur or nitrogen, are converted into inorganic gases such as hydrogen sulfide or ammonia. The sour hydrocarbon mixture 6 is directed to the feed inlet of a means of separation, here a stripper 8 having a feed inlet, a liquid outlet and a vapor outlet. In addition to the sour hydrocarbon mixture 6 the stripper may receive a stripping medium or it may operate by reboiling. In the stripper the sour hydrocarbon mixture is separated in a gas mixture 10 comprising hydrocarbon and sour gas withdrawn from the vapor outlet, and a liquid stripper product 12. The gas mixture 10 is directed to a gas inlet of a sour gas absorber 14, containing an absorbent liquid having affinity for sour gas. The sour gas absorber 14 further has an inlet for lean sour gas absorbent liquid 16, an outlet for rich sour gas absorbent liquid 18 and an outlet for purified off-gas 20. The purified off-gas 20 is directed to flare, and the liquid stripper product 12 is directed to further refinery operations.

### EXAMPLES

In a first set of examples, Examples 1 and 2, the operation of a process as disclosed, is compared to a process according to the prior art, without an oil absorber, for the desulfurization of a stream of condensate oil.

In a second set of examples, Examples 3 and 4, the operation of a process as disclosed is compared to a process according to the prior art, without an oil absorber, for the desulfurization of a stream of naphtha.

In Example 1 the condensate oil characterized in Table 1 was hydrotreated over a cobalt molybdenum catalyst on an alumina support, at 334° C., 46 barg, LHSV 3.5 I/NL, followed by stripping in a stripper operating 6.7 barg pressure and 58° C. to 218° C. from top to bottom of the stripper. The vapor phase from the stripper was directed as a gas mixture to a sour gas absorber where hydrogen sulfide was captured in an absorbent comprising methyl diethanolamine at a temperature of 63° C.

In Example 2 the product characterized in Table 1 was hydrotreated and stripped under the same conditions as in Example 1. The vapor phase from the stripper was directed as a gas mixture to a sour gas absorber (operating at 63° C.). The purified gas mixture from the sour gas absorber was directed to an oil absorber where an amount of the hydrocarbons was recovered in a liquid hydrocarbon mixture at 67° C. The flow rate of the liquid hydrocarbon mixture was adjusted to meet the desired RVP of the product, and thus the optimal yield providing a product meeting the required specifications. This process corresponds to the process shown in FIG. 2.

Table 2 shows a comparison of the Examples 1 and 2. It can be seen that the product of Example 2 has a higher RVP compared to the product of Example 1, and also the yield of Example 2 is 1% higher, while the H₂S content according to both examples is the same.

In Example 3 the naphtha feedstock characterized in Table 3 was hydrotreated over a cobalt molybdenum catalyst on an alumina support, at 334° C., 46 barg, LHSV 3.5 I/NL, followed by stripping in a stripper operating 6.7 barg pressure and 58° C. to 218° C. from top to bottom of the stripper. The vapor phase from the stripper was directed as a gas mixture to a sour gas absorber where hydrogen sulfide was captured at 80° C. in an absorbent comprising methyl diethanolamine at a temperature of 60° C.

In Example 4 the product characterized in Table 3 was hydrotreated and stripped under the same conditions as in Example 3. The vapor phase from the stripper was directed as a gas mixture to a sour gas absorber (operating at 80° C.). The purified gas mixture from the sour gas absorber was directed to an oil absorber where an amount of the hydrocarbons was recovered in a liquid hydrocarbon mixture at 60° C. The flow rate of the liquid hydrocarbon mixture was adjusted to meet the desired RVP of the product, and thus the optimal yield providing a product meeting the required specifications. This process corresponds to the process shown in FIG. 2.

Table 4 shows a comparison of the Examples 3 and 4. It can be seen that the product of Example 2 has a higher RVP compared to the product of Example 1, and also the yield of Example 2 is 1% higher, while the H₂S content according to both examples is the same.

From both sets of examples it is seen that the yield of the process can be increased by operation according to the present disclosure, relative to the prior art, while adhering to RVP specifications.

TABLE 1

| Feed type | | Condensate oil | |
|---|---|---|---|
| Specific gravity | | SG 60/60 F. | 0.798 |
| Sulphur content | | ppm wt | 290 |
| Distillation curve | ASTM D 86 | | |
| IBP | | ° C. | 45 |
| 5% | | ° C. | 72 |
| 10% | | ° C. | 96 |
| 30% | | ° C. | 128 |
| 50% | | ° C. | 221 |
| 70% | | ° C. | 230 |
| 90% | | ° C. | 340 |

TABLE 2
COMPARISON

| | | RVP | H₂S | Yield |
|---|---|---|---|---|
| | | PSIA | ppm wt | Relative |
| Example1 | No oil absorber | 2.2 | 9.1 | 100 |
| Example2 | With oil absorber | 8.1 | 9.1 | 101 |

TABLE 3

| Feed type | | Naphtha | |
|---|---|---|---|
| Specific gravity | | SG 60/60 F. | 0.711 |
| Sulphur content | | ppm wt | 300 |
| Total nitrogen | | ppm wt | 0.6 |
| Distillation curve | ASTM D 86 | | |
| IBP | | ° C. | 59 |
| 5% | | ° C. | 59.4 |
| 10% | | ° C. | 61 |
| 30% | | ° C. | 78 |
| 50% | | ° C. | 100 |
| 70% | | ° C. | 109 |
| 90% | | ° C. | 135 |

TABLE 4
COMPARISON

| | | RVP | H₂S | Yield |
|---|---|---|---|---|
| | | PSIA | ppm wt | Relative |
| Example 3 | No oil absorber | 5.2 | 0.025 | 100.0 |
| Example 4 | With oil absorber | 12.0 | 0.025 | 101.3 |

1. A process for purification of a sour hydrocarbon mixture, comprising the steps of
a. directing said sour hydrocarbon mixture to a means of separation, optionally a stripper, providing a liquid hydrocarbon fraction and a gas mixture,
b. directing the gas mixture to contact an absorbent liquid having affinity for sour gas, providing a purified off-gas mixture,
c. directing the purified off-gas mixture to contact a liquid hydrocarbon mixture, providing an enriched liquid hydrocarbon mixture.

2. A process for purification of a sour hydrocarbon mixture according to claim 1, wherein said liquid hydrocarbon mixture has a temperature in the range from 30° C. to 70° C., when contacted with said gas mixture.

3. A process for purification of a sour hydrocarbon mixture according to claim 1, wherein said absorbent liquid having affinity for sour gas has a temperature in the range from 30° C. to 90° C. and a pressure in the range of atmospheric to 30 barg.

4. A process for purification of a sour hydrocarbon mixture according to claim 3, wherein said absorbent liquid comprises an amine, an inorganic base, an ionic liquid or a physical solvent, comprising one or more compounds taken from the group comprising methanol, dimethyl ethers of polyethylene glycol, propylene carbonate and n-methyl-2-pyrrolidone.

5. A process for purification of a sour hydrocarbon mixture according to claim 1, wherein said liquid hydrocarbon mixture comprises at least a part of said liquid hydrocarbon fraction.

6. A process for purification of a sour hydrocarbon mixture according to claim 1, wherein said sour hydrocarbon mixture comprises at least 30% by weight, boiling in the range from 30° C. to 200° C.

7. A process for purification of a sour hydrocarbon mixture according to claim 1, wherein said sour hydrocarbon mixture comprises at least 2% hydrocarbons by weight, boiling below 30° C.

8. A process for production of a purified hydrocarbon mixture from a heteroatomic hydrocarbon mixture, comprising the process steps for purification of a sour hydrocarbon mixture according to claim 1, wherein said heteroatomic hydrocarbon mixture is directed to contact a material catalytically active in hydrotreatment under hydrotreatment conditions, providing the sour hydrocarbon mixture.

9. A process for production of a purified hydrocarbon mixture according to claim 8, wherein said hydrotreatment conditions involve a temperature from 250° C. to 450° C., a pressure from 10 barg to 100 barg, and a liquid hourly space velocity from 0.5 m³/m³/h and wherein said material catalytically active in hydrotreatment comprises molybdenum or tungsten optionally in combination with cobalt or nickel and supported on a support comprising a support material.

10. A process for production of a purified hydrocarbon mixture according to claim 8 wherein said heteroatomic hydrocarbon mixture is a condensate oil, a feedstock comprising naphtha or a product from a hydrocracking process comprising naphtha.

11. A process unit for purification of a gas mixture comprising hydrocarbon and hydrogen sulfide comprising a sour gas absorber and an oil absorber, each having a gas inlet, a gas outlet, a liquid inlet and a liquid outlet, wherein the gas mixture is directed to the gas inlet of said sour gas absorber, and the gas outlet of said sour gas absorber is in fluid communication with said oil absorber gas inlet, and where said oil absorber liquid outlet provides an enriched liquid hydrocarbon mixture.

12. A process unit for purification of a sour hydrocarbon mixture, comprising a process unit according to claim 11, and a means of separation having an inlet, a vapor outlet, a liquid outlet and optionally a stripping medium inlet, wherein said sour hydrocarbon mixture is directed to said inlet of the means of separation, and the vapor outlet of the means of separation is in fluid communication with the gas inlet of the sour gas absorber, and wherein the liquid outlet of the means of separation optionally is in fluid communication with the liquid inlet of the oil absorber.

13. A process plant for production of a purified hydrocarbon mixture from a heteroatomic hydrocarbon mixture, comprising a hydrotreatment reactor having an inlet and an outlet, said hydrotreatment reactor containing a material catalytically active in hydrotreatment, wherein the heteroatomic hydrocarbon mixture is directed to the inlet of the hydrotreatment reactor and outlet of hydrotreatment reactor is in fluid communication with the inlet of the means of separation.
